(19) United States
(12) Patent Application Publication
(10) Pub. No.: US 2024/0008472 A1
(43) Pub. Date: Jan. 11, 2024

(54) HEAT TRANSFER ADAPTER FOR INSECT REPELLENT SYSTEM

(71) Applicant: Thermacell Repellents, Inc., Bedford, MA (US)

(72) Inventor: Wender Wang, Wilmingtom, MA (US)

(73) Assignee: Thermacell Repellents, Inc., Bedford, MA (US)

(21) Appl. No.: 18/218,863

(22) Filed: Jul. 6, 2023

Related U.S. Application Data
(60) Provisional application No. 63/358,712, filed on Jul. 6, 2022.

(51) Int. Cl. A01M 1/20

(52) U.S. Cl. CPC A01M 1/2088

(57) ABSTRACT

An insect repellent adaptor is configured for use with an insect repellent device and includes an insect repellent bottle; a wick having a first end extending into an interior of the insect repellent bottle and a second end extending outwardly from the insect repellent bottle; a base having a wick heater extending outwardly thereof, and a bottle top having a bottle holder configured to attach the insect repellent bottle thereto; and a heating element. The wick heater is configured for insertion into the insect repellent device adjacent a heating plate thereof. The base includes a cylindrical chimney centrally formed in and extending through the base, wherein the chimney is configured to conduct heated, evaporated, volatilized material from the insect repellent bottle, via the wick, out of the base, and into the surrounding air. The heating element is cylindrical and has a diameter larger than a diameter of the chimney, is coaxially formed therewith, and is formed from a thermally conductive material.

### CROSS-REFERENCE TO RELATED APPLICATIONS

This application claims the benefit of U.S. Provisional Application No. 63/358,712, filed Jul. 6, 2022, the disclosure of which is incorporated herein by reference in its entirety.

### BACKGROUND OF THE INVENTION

This invention relates in general to camping heaters and insect repellent devices. In particular, this invention relates to an insect repellent adapter for use with such camping heaters and insect repellent devices that enables a larger, longer lasting supply of insect repellent to be dispensed by the camping heaters and insect repellent devices.

A known insect repellent device is disclosed in U.S. Pat. No. 10,051,852 and includes a conventional fuel canister attached to an insect repellent device. The insect repellent device includes a heating plate that heats an insect repellent mat that is impregnated with insect repellent. The heating plate heats the insect repellent mat and causes the impregnated mat to disperse insect repellent chemicals to provide a reasonably sized insect free area.

Compressed gas cooking stoves are also known and may be used in various outdoor environments, including camp sites and refugee camps. Such compressed gas cooking stoves may use the same type of conventional fuel cannister as used in known insect repellent devices, such as the insect repellent device disclosed in U.S. Pat. No. 10,051,852.

Many campers, RV users, hunters and backpackers who enjoy the outdoors are subject to insect attacks for extended periods of time. Additionally, refugees at refugee camps around the world are also subject to insect attacks for extended periods of time. The operating times of conventional insect repellent devices, such as the insect repellent device described in U.S. Pat. No. 10,051,852 is limited by the amount of insect repellent mat impregnated in the insect repellent mat. In addition, the amount of fuel available to heat and volatize the repellent material can also limit operating time.

Thus, there remains a need for longer term use of insect repellent devices that allows a conventional camp powered by a portable fuel source. Additionally, there remains a need for a device that allows a conventional compressed gas cooking stoves to be modified to also function as an insect repellent device.

### SUMMARY OF THE INVENTION

This invention relates to an improved insect repellent adaptor that is configured for use with an insect repellent device. The insect repellent adaptor includes an insect repellent bottle; a wick having a first end extending into an interior of the insect repellent bottle and a second end extending outwardly from the insect repellent bottle; a base having a wick heater extending outwardly thereof, and a bottle top having a bottle holder configured to attach the insect repellent bottle thereto; and a heating element. The wick heater is configured for insertion into the insect repellent device adjacent a heating plate thereof. The base includes a cylindrical chimney centrally formed in and extending through the base, wherein the chimney is configured to conduct heated, evaporated, volatilized material from the insect repellent bottle, via the wick, out of the base, and into the surrounding air. The heating element is cylindrical and has a diameter larger than a diameter of the chimney, is coaxially formed therewith, and is formed from a thermally conductive material.

In certain embodiments, the invention defines an insect repellent adaptor comprising a thermal conduit and a base. The thermal conduit is disposed proximate to a combustion chamber to conduct combustion heat to a heating element. The base encapsulates the heating element and supports an insect repellent reservoir. The insect repellent reservoir has a wick extending from the insect repellent reservoir into the heating element. In an aspect of the invention, the thermal conduit includes a conductor having a first side configured to engage a heat plate of the combustion chamber and an insulating material covering a second side of the conductor. In some embodiments, the insulating material forms the base.

In certain embodiments, the invention defines an insect repellent adaptor comprising a thermal conduit and a base. The thermal conduit is disposed proximate to a combustion chamber to conduct combustion heat to a heating element. The base encapsulates the heating element and supports an insect repellent reservoir. The insect repellent reservoir has a wick extending from the insect repellent reservoir into the heating element. The heat plate and combustion chamber forming part of a gaseous-fuel powered insect repeller, and the heat plate defines a portion of a slot configured to accept the thermal conduit. Another aspect of the invention includes a grill that cooperates with the heat plate to define a slot configured to receive an insect repellent impregnated mat. The slot also is configured to receive the thermal conduit.

In other embodiments of the invention, the invention defines an insect repellent adaptor comprising a thermal conduit and a base. The thermal conduit is disposed proximate to a combustion chamber to conduct combustion heat to a heating element. The base encapsulates the heating element and supports an insect repellent reservoir. The insect repellent reservoir has a wick extending from the insect repellent reservoir into the heating element. The heating element includes a chimney that accepts the wick, and the base including a bottle holder that supports a bottle mount of the insect repellent reservoir relative to the heating element. In certain aspects of the invention, the bottle holder and the bottle mount are configured as one of a detent and projection interface or a threaded element and plate. The thermal conduit includes a conductor having a first side configured to engage a heat plate, the conductor and the heating element formed from a thermally conductive material. The conductor has a second side covered with an insulating material. A grill cooperates with the heat plate to define a slot configured to receive an insect repellent impregnated mat and that also accepts the thermal conduit. The heat plate and combustion chamber form part of a gaseous-fuel powered insect repeller.

In one embodiment of the invention, an insect repellent adapter includes a thermal conduit and a base. The thermal conduit includes a conductor having a first side configured to engage a heat plate of a combustion chamber and an insulating material covering a second side of the conductor. The insulating material forms a portion of the base. The base supports a heating element and includes a bottle holder that attaches to an insect repellent reservoir. The heating element includes a chimney that accepts a wick extending from the insect repellent reservoir. The base includes a bottle holder that supports a bottle mount of the insect repellent reservoir relative to the heating element. The heat plate and combustion chamber forming part of a gaseous-fuel powered insect repeller.

Various aspects of this invention will become apparent to those skilled in the art from the following detailed description of the preferred embodiment, when read in light of the accompanying drawings.

### BRIEF DESCRIPTION OF THE DRAWINGS

FIG. 1 is a partially exploded perspective view of an insect repellent device and a first embodiment of an insect repellent adaptor in accordance with this invention.

FIG. 2 is a perspective view of the insect repellent device illustrated in FIG. 1 showing the insect repellent adaptor mounted thereto.

FIG. 3A is a perspective view of the insect repellent adaptor shown in FIGS. 1 and 2.

FIG. 3B is a cross-sectional view of the insect repellent adaptor taken along the line 3B-3B in FIG. 3A.

FIG. 4 is a cross-sectional plan view of the insect repellent device having the insect repellent adaptor mounted thereto as shown in FIGS. 1 and 2.

FIG. 5 is a perspective view of a portion of an alternate embodiment of the insect repellent adaptor shown in FIGS. 1, 2, and 3A.

FIG. 6 is a cross-sectional plan view of another alternate embodiment of the insect repellent adaptor shown in FIGS. 1, 2, and 3A showing the rotation mechanism.

FIG. 7 is an alternate cross-sectional plan view of the insect repellent adaptor shown in FIG. 6.

FIG. 8 is a partially exploded perspective view of an alternate embodiment of a portable insect repellent device and the alternate embodiment of the insect repellent adaptor shown in FIGS. 6 and 7.

### DETAILED DESCRIPTION OF THE PREFERRED EMBODIMENT

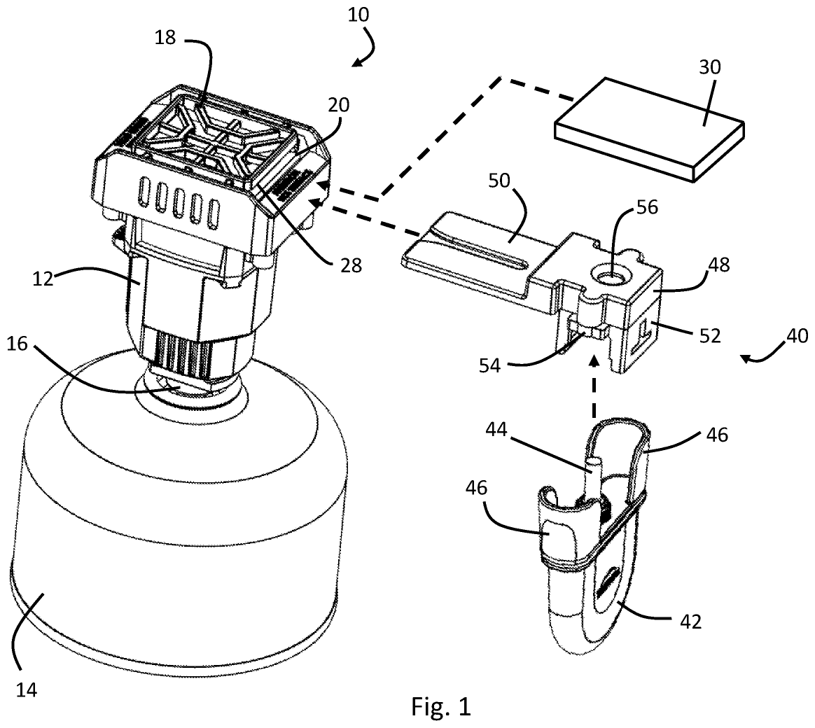

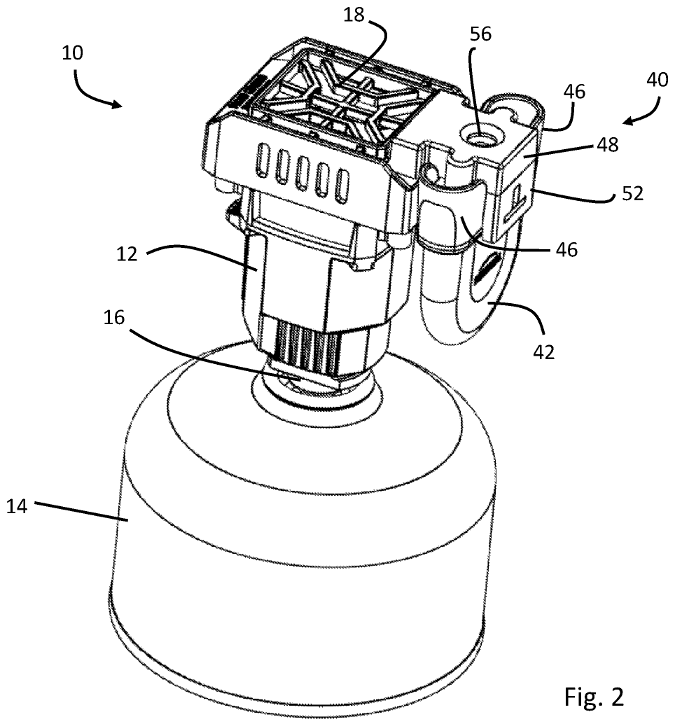

Referring now to the drawings, there is illustrated in FIGS. 1 and 2 an insect repellent device, indicated generally at 10. The illustrated insect repellent device 10 is, in large measure, conventional in the art and is intended merely to illustrate one environment in which this invention may be used. Thus, the scope of this invention is not intended to be limited for use with the specific structure for the insect repellent device 10 illustrated in FIGS. 1 and 2 or with insect repellent devices in general. On the contrary, as will become apparent below, this invention may be used in any desired environment for the purposes described below.

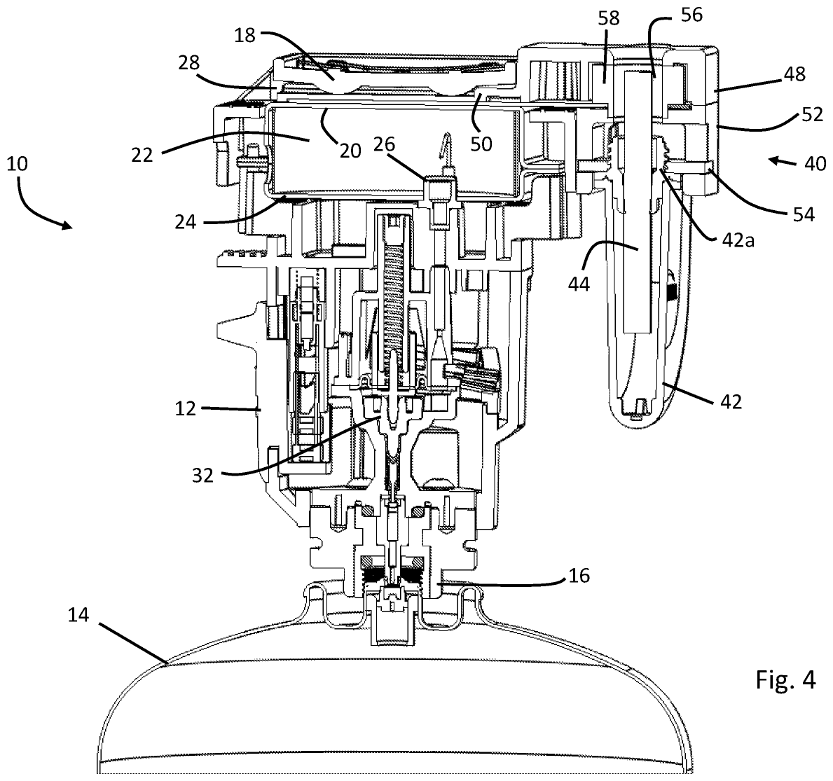

The illustrated insect repellent device 10 includes a housing 12 attached to a fuel canister 14 via a connector 16. The fuel canister 14 contains a gaseous-fuel such as propane, butane, or another combustible fuel material. The housing 12 may be formed from plastic and includes a protective grill 18 at a distal end thereof. A heating plate 20 defines one wall of a combustion chamber 22, best shown in FIG. 4. A second wall 24 of the combustion chamber 22 includes a burner 26, and a space between the heating plate 20 and the protective grill 18 defines a slot 28 configured to receive an insect repellent impregnated mat 30 in the conventional embodiment. A regulator valve 32 extends between the fuel cannister 14 and the burner 26.

The regulator valve 32 regulates gas flow, and thereby maintains and controls temperature to heat the heating plate 20 and heat the mat thereupon to dispense volatile substances impregnated into the mat 30. The regulator valve 32 is normally off. The regulator valve 32 is configured to finely control the amount of fuel passing from the fuel canister 14 to the burner 26 to control the temperature of the heating plate 20 and the dispersion of the volatile insect repellent materials within the mat 30.

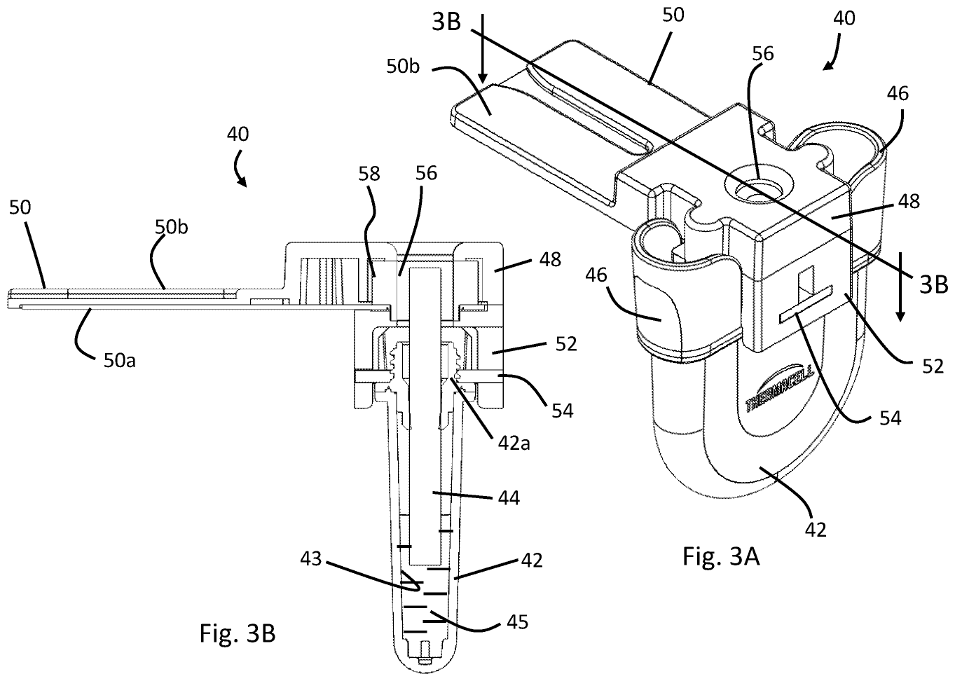

Also illustrated in FIGS. 1 and 2 is a first embodiment of an insect repellent adaptor, indicated generally at 40, in accordance with this invention. The insect repellent adaptor 40 supports a re-fillable insect repellent reservoir or insect repellent bottle 42 which may contain a volume of insect repellent, such as for example a volume of metofluthrin insect repellent, which is volatized from a liquid state. In certain embodiments, the reservoir 42 may contain a sufficient amount of repellent to last within the range of about 12 hours to about 40 hours when the insect repellent device 10 is in operation, though any other amounts of repellent material are considered to be within the scope of the invention. The bottle 42 includes a wick 44 and, in certain embodiments, wings 46. The wick 44 extends into an interior 43 of the bottle 42, as shown in FIG. 3B. Insect repellent comprising liquid volatiles, such as metofluthrin, 45 contained within the bottle 42 are conducted by capillary action through the wick 44 out of the bottle 42 and to a distal end of the wick 44 (the upper end when viewing FIG. 1). To ensure that the complete volume of insect repellent contained within the bottle 42 is conducted by capillary action out of the bottle 42 and to a distal end of the wick 44, it is advantageous for the wick 44 to be generally vertically oriented. The vertical orientation of the wick 44 may be maintained by ensuring that a rounded bottom or low point of the bottle 42 is oriented downwardly, i.e., towards the ground. The bottle 42 vented to prevent a vacuum lock, but is otherwise sealed to prevent the user from coming into contact with the liquid contents.

The illustrated bottle 42 includes the wings 46 that extend axially adjacent to wick 44. The wings 46 are configured to protect the wick 44 from impact and physical damage. The wings 46 may also serve as guide members to align the bottle 42 with a heating element 58, described below, so that the wick 44 is centered within the heating element 58. The illustrated bottle 42 includes the rounded bottom, into which the wick 44 is fully extended, so as to minimize residual, unused liquid insect repellent 45 when the bottle 42 is exhausted. It will be appreciated however, that any bottle configuration may be used with this invention.

The insect repellent adaptor 40 also includes a base 48 having a thermal conduit 50 extending outwardly thereof, and a bottle top 52 having a bottle holder 54 configured to attach the bottle 42 thereto. As shown in FIGS. 3B and 4, the bottle holder 54 may be configured as a snap-fit or expandable plate, or other engagement structure, that engages a bottle mount 42a proximate to the wick 44. The bottle mount 42a is illustrated as a threaded section or alternatively a barbed or other projecting feature. The thermal conduit 50 includes a conductor 50a connected to the heating element 58 to pass thermal energy from a heat source to the heating element 58. The conductor 50a and the heating element 58 may be formed from any desired thermally conductive material, such as but not limited to aluminum, copper, brass, bronze, and metal-coated ceramics, for example. In one embodiment, the thermal conduit 50 may have the thermally conductive material of the conductor 50a exposed to a side that contacts the heat plate 20. The other sides of the thermal conduit 50 may be coated with an insulating material 50b, such as ceramic, plastic, or other thermally non-conductive material to direct more heat to the heating element 58. This configuration improves thermal conduction efficiency and extends fuel time of operation.

The base 48 includes a cylindrical chimney 56 centrally formed in and extending through the base 48. The chimney 56 is configured to conduct heated, evaporated, volatilized material out of the base 48 and into the surrounding air. The heating element 58 is illustrated being cylindrical and has a diameter larger than a diameter of the chimney 56, is coaxially formed therewith, and is formed from a thermally conductive material.

When assembled, as shown in FIG. 3A, the insect repellent adaptor 40 may be mounted to the insect repellent device 10 by inserting the thermal conduit into the slot 28, in lieu of the insect repellent impregnated mat 30.

In operation, heat from the heating plate 20 is transferred to the thermal conduit 50 and to the heating element 58. The heating element 58 heats the wick 44 so as to disperse the volatile insect repellent materials within the wick 44 through the chimney 56 and into the surrounding air.

Alternatively, the insect repellent adapter 40 may be modified to be attached to a conventional camping stove (not shown) that uses a fuel cannister, such as the fuel cannister 14.

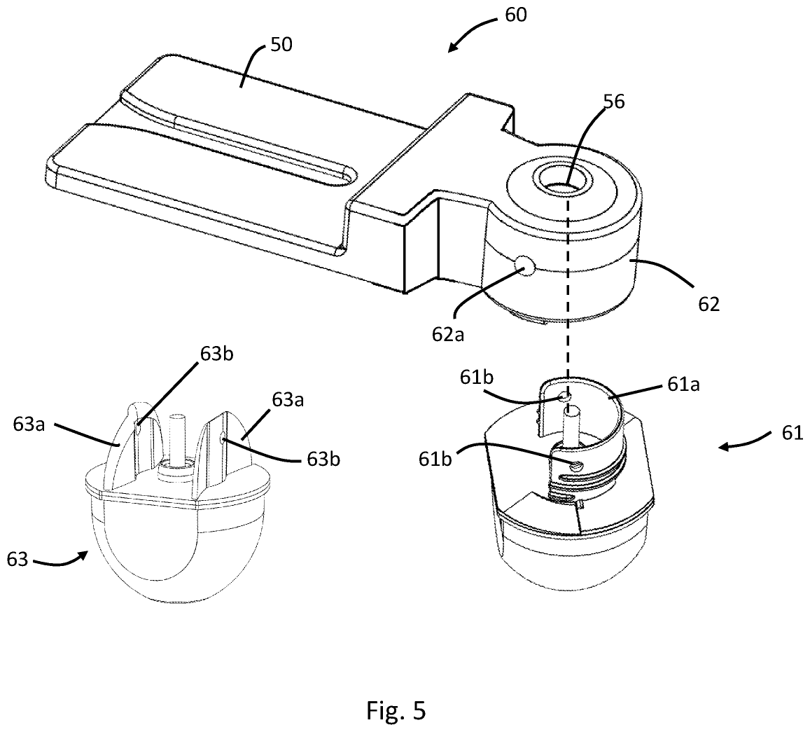

FIG. 5 illustrates an alternate embodiment of the insect repellent adaptor, shown generally at 60. The insect repellent adaptor 60 is similar to the insect repellent adaptor 40, but includes a base 62 configured for attachment to an alternate embodiment of a reservoir, shown generally at 61. The reservoir 61 includes a collar 61a having retaining detents 61b that engage mating protrusions 62a extending from the base 62. This configuration permits a snap-in attachment of the reservoir 61 to the base 62. Alternatively, the collar 61a may be configured as spaced-apart walls or wings 63a having retaining detents 63b extending from a reservoir 63. Alternatively, the detents and projections may be mounted in reversed.

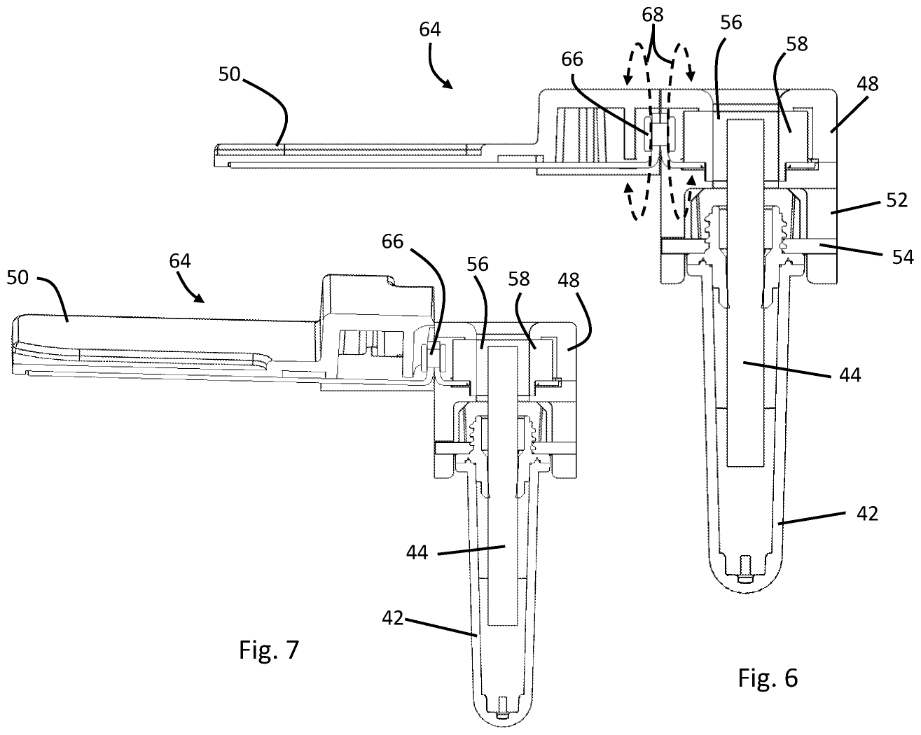

FIG. 6 illustrates an alternate embodiment of the insect repellent adaptor, shown generally at 64. The insect repellent adaptor 64 is similar to the insect repellent adaptor 40, but includes a rotation mechanism 66 between the base 48 and the thermal conduit 50. The rotation mechanism 66 is configured to allow the base 48 and the thermal conduit 50 to rotate 360 degrees relative to one another (see the arrows 68). For example, as shown in FIG. 7, the thermal conduit 50 of the insect repellent adaptor 64 is shown slightly rotated.

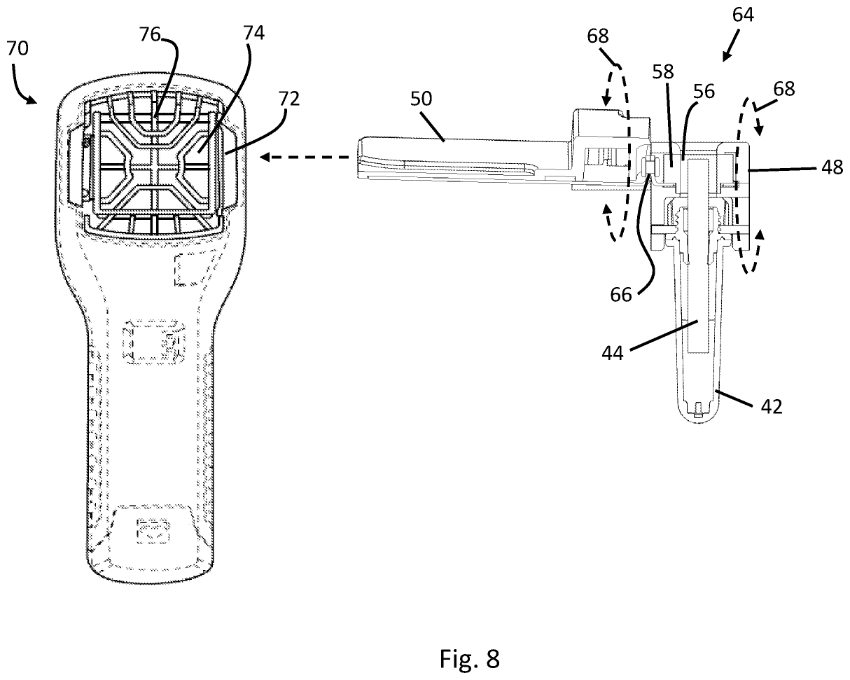

For example, when using an alternate embodiment of the insect repellent device, such as the portable insect repellent device 70, shown in FIG. 8, it may be advantageous to rotate the thermal conduit 50 relative to the base 48 and the attached bottle 42. The portable insect repellent device 70 includes the slot 72 defined between the heating plate 74 and the protective grill 76.

Therefore, when the thermal conduit 50 is inserted into the slot 72, the base 48 and the attached bottle 42 may be rotated as necessary depending on the position in which the user is holding the portable insect repellent device 70 so as to keep the rounded bottom of the bottle 42 oriented downwardly, i.e., towards the ground. In this orientation, the wick 44 remains vertically oriented, thus the insect repellent contained within the bottle 42 is conducted by capillary action out of the bottle 42 and to a distal end of the wick 44 where the insect repellent is heated and volatilized, as described above.

The principle and mode of operation of this invention have been explained and illustrated in its preferred embodiment. However, it must be understood that this invention may be practiced otherwise than as specifically explained and illustrated without departing from its spirit or scope.

What is claimed is:

1. An insect repellent adaptor comprising:
a thermal conduit configured to be disposed proximate to a combustion chamber to conduct combustion heat to a heating element; and
a base encapsulating the heating element and configured to support an insect repellent reservoir, the insect repellent reservoir having a wick extending from the insect repellent reservoir into the heating element.

2. The insect repellent adaptor of claim 1 wherein the thermal conduit includes a conductor having a first side configured to engage a heat plate of the combustion chamber and an insulating material covering a second side of the conductor, the insulating material forming the base.

3. The insect repellent adaptor of claim 2 wherein the heat plate and combustion chamber forming part of a gaseous-fuel powered insect repeller, the heat plate defining a portion of a slot configured to accept the thermal conduit.

4. The insect repellent adaptor of claim 3 wherein a grill cooperates with the heat plate to define the slot, the slot configured to receive an insect repellent impregnated mat.

5. The insect repellent adaptor of claim 1 wherein the heating element includes a chimney that accepts the wick, the base including a bottle holder that supports a bottle mount of the insect repellent reservoir relative to the heating element.

6. The insect repellent adaptor of claim 5 wherein the bottle holder and the bottle mount are configured as one of a detent and projection interface or a threaded element and plate.

7. The insect repellent adaptor of claim 5 wherein the thermal conduit includes a conductor having a first side configured to engage a heat plate, the conductor and the heating element formed from a thermally conductive material.

8. The insect repellent adaptor of claim 7 wherein the conductor has a second side covered with an insulating material, a grill cooperates with the heat plate to define the slot, the slot configured to receive an insect repellent impregnated mat and accepts the thermal conduit, the heat plate and combustion chamber forming part of a gaseous-fuel powered insect repeller.

9. The insect repellent adaptor of claim 1 wherein the thermal conduit includes a conductor having a first side configured to engage a heat plate of the combustion chamber and an insulating material covering a second side of the conductor, the insulating material forming the base;
the heating element includes a chimney that accepts the wick, the base including a bottle holder that supports a bottle mount of the insect repellent reservoir relative to the heating element; and
the heat plate and combustion chamber forming part of a gaseous-fuel powered insect repeller.

10. An insect repellent adaptor configured for use with an insect repellent device, the insect repellent adaptor comprising:
an insect repellent bottle;
a wick having a first end extending into an interior of the insect repellent bottle and a second end extending outwardly from the insect repellent bottle;
a base having a thermal conduit extending outwardly thereof, and a bottle top having a bottle holder configured to attach the insect repellent bottle thereto; and
a heating element in thermal communication with the thermal conduit;
wherein the thermal conduit is configured for insertion into the insect repellent device adjacent a heating plate thereof;
wherein the base includes a cylindrical chimney centrally formed in and extending through the base, the chimney configured to conduct heated, evaporated, volatilized material from the insect repellent bottle, via the wick, out of the base, and into the surrounding air; and
wherein the heating element is cylindrical and has a diameter larger than a diameter of the chimney, is coaxially formed therewith, and is formed from a thermally conductive material.

11. The insect repellent adaptor according to claim 10, further including a rotation mechanism between the base and the wick heater, the rotation mechanism configured to allow the base and the wick heater to rotate 360 degrees relative to one another.
